(19) United States
(12) Patent Application Publication
(10) Pub. No.: US 2014/0053233 A1
(43) Pub. Date: Feb. 20, 2014

(54) ONLINE MEDIA POLICY PLATFORM

(71) Applicant: David Jacobs, London (GB)

(72) Inventor: David Jacobs, London (GB)

(21) Appl. No.: 13/970,255

(22) Filed: Aug. 19, 2013

Related U.S. Application Data
(60) Provisional application No. 61/691,172, filed on Aug. 20, 2012.

(51) Int. Cl. H04L 29/06

(52) U.S. Cl. CPC H04L 63/20
USPC 726/1

(57) ABSTRACT

An online media policy platform comprises: a policy engine, and a sampler adapted to sample content of digital media, the sampler being further adapted to request policies from the policy engine that are applicable to the requested content. The platform further comprises a discriminator adapted to determine a condition that the content is to be consumed under. The platform further comprises a decision tree, which uses inputs from the discriminator to determine which policy to apply to the content. The platform retrieves enforcement instructions from the policy engine and enforces the policy at a device or network enforcement point so that access to the content is controlled.

### CROSS-REFERENCE TO RELATED APPLICATIONS

The present application claims priority to U.S. Provisional Patent Application Ser. No. 61/691,172 filed on filed on Aug. 20, 2012, the entire disclosure of which is incorporated herein by reference.

### FIELD OF THE INVENTION

The invention relates to a context based online media policy platform.

### BACKGROUND OF THE INVENTION

Copyright infringement among consumers of digital media represents a significant economic challenge to content creators and providers. As the technology to distribute digital media online has developed, piracy techniques have developed alongside, enabling the consumption of media without payment to the creator.

The known content protection technologies control access to and use of the content and limit its unauthorized copying and redistribution. Examples of such technology can be found in WO2009/126829, U.S. Patent Publication No. 2009/196465 and U.S. Patent Publication No. 2012/011560. Parties seeking to engage in unauthorized distribution and copying of protected commercial music or video content can circumvent the content protection to obtain a decrypted copy of the content. Once a decrypted copy of the content is obtained, the content protection technology is no longer effective at governing access to it and the decrypted content may be subject to unlimited use, copying, and redistribution in particular via online techniques.

Recently content providers have begun to release media with digital watermarks. Digital watermarks comprise identifying data, which is woven into media content such as images, movies, music or programming such as games or TV episodes, thereby giving those objects a unique, digital identity that can be used for a variety of valuable applications. An example of the possible applications can be seen in U.S. Patent Publication No. 2013/0205317. Digital watermarks are imperceptible to the human senses yet easily recognized by special software detectors, and a digital watermark remains constant even through recording, manipulation and editing, compression and decompression, encryption, decryption and broadcast. Digital watermarks are useful in establishing copyright ownership and tracing the source of an infringing work. Some media players can be adapted to recognize digital watermarks so that they can be used to recognize that a work has been copied from a different format, e.g., if a film has been recorded in a theatre and converted to a DVD format, it would be possible to prevent the DVD from being replayed.

Consumers of digital media can be categorised into three groups. The first group consists of consumers who will only access digital media using established services where there is no problem with piracy. The second group consists of those consumers who will never pay for online content as a matter of principle. However, the largest group consists of people who are simply interested in accessing a particular piece of content irrespective of whether the source is legitimate or pirated. For this group of consumers the more limited selection of media on the established paid for services results in them looking for media through other outlets. A large amount of media is available for free via Torrents and other peer to peer (P2P) systems. Access to this media is technically difficult to control.

### SUMMARY OF THE INVENTION

The present invention seeks to provide a media policy platform adapted to trigger actions based on identification of and/or the usage-context of how the media is consumed.

According to the invention there is provided an online media policy platform comprising a policy engine, a sampler adapted to sample content of digital media, the sampler being further adapted to request policies from the policy engine that are applicable to the requested content, the platform further comprising a discriminator adapted to determine a condition that the content is to be consumed under, the platform further comprising a decision tree, which decision tree uses inputs from the discriminator to determine which policy to apply to the content, wherein the platform retrieves enforcement instructions from the policy engine and enforces the policy.

Preferably, the platform is adapted to determine the identity of sampled content and access rules applicable to the identified content. Preferably, the discriminator determines an access status for the content. Preferably, the access status, the identity of the content and usage context conditions are fed to a decision tree to determine the policy to be applied. Preferably, the policy is returned to the sampler for enforcement. Preferably, the sampler comprises a device or network sampling and enforcement point. Preferably, the platform is adapted to control access to the media. Preferably, access to the media is blocked. Alternatively, the user is diverted from the source of the sampled content to an alternative source of the content.

According to a second aspect of the invention there is provided a method of controlling access to digital media comprising the steps of sampling the media at a sampling point, identifying the content of the media, determining any usage conditions on the content of the media and controlling further access to the media through the sampling point in dependence on the content of the media and usage conditions.

According to a third aspect of the invention there is provided a method of providing a feed of source addresses of malware sites comprising the steps of sampling the media at a sampling point, identifying the content of the media, determining any usage conditions on the content of the media, wherein the sampling point identifies the IP address or addresses of the source of the sampled media and if the usage conditions indicate that the source is not a permitted source for the content, the IP address or addresses of the source of the sampled media are supplied to a network provider.

The system of the invention can therefore identify content and determine the context of the use of the content. This in turn enables the delivery of a policy. The policy, can control access to the content and can also control behaviour of a content player. It can further trigger notifications to a consumer such as where content can be legally accessed or alternatively, product tie-ins such as they can get a drink in the same coffee bar as the person in the content they are viewing.

### BRIEF DESCRIPTION OF THE DRAWINGS

Exemplary embodiment of the invention will now be described in greater detail with reference to the drawings in which:

FIG. 1 shows schematically the system of the invention;

FIG. 1a shows schematically the policy management interfaces;

FIG. 2 shows schematically the usage context of streamed content;

FIG. 3 shows Context Based Policy Selection;

FIG. 4 shows a pirate content decision tree;

FIG. 5 shows a permissible content decision tree;

FIG. 6 shows the sequence diagram for anonymising samples & notifications;

FIG. 7 shows the sequence diagram for collecting community decoy samples; and

FIG. 8 shows the sequence diagram for donating community decoy samples.

### DETAILED DESCRIPTION OF THE INVENTION

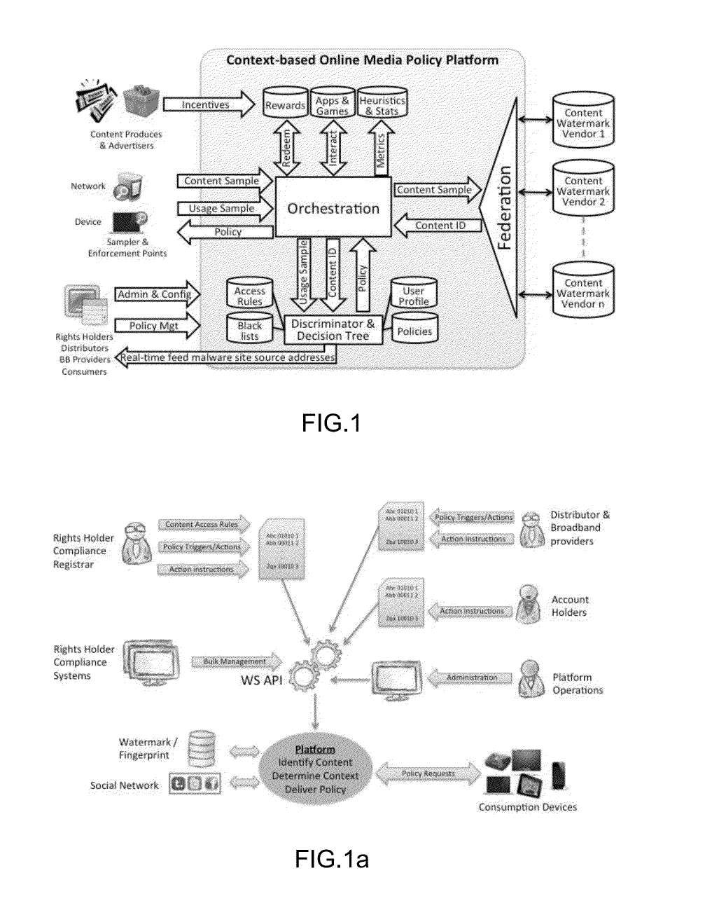

FIG. 1 shows schematically the context-based online media policy platform. The Context-based Online Media Policy (COMP) platform can be used by both device and network sampling and enforcement points. The platform incorporates the databases and orchestration functions for content identification, determining usage context and servicing the designated policies to be enforced. The platform further comprises a digital watermark federator function, which is adapted to communicate with a plurality of content watermark vendors so as to be able to identify watermarks in an analysed piece of digital content.

The Device-based Sampler and Enforcement Point (DSEP) is a software application that runs on consumer network devices such as residential gateways such as routers and consumption devices such as computers, set top boxes, game consoles, smart TVs or tablets that are used to browse and consume digital assets.

The Network-based Sampler and Enforcement Point (NSEP) is an application that consumes information flows from a Deep Packet Inspection (DPI) probe located in a Broadband provider's access network.

Rights holders, Distributors, Broadband service providers and account holders can define, configure and manage policies on an individual basis via web based interfaces. Web Services APIs are provided for integration with Rights holder compliance systems.

### Streaming Content and its Usage Context

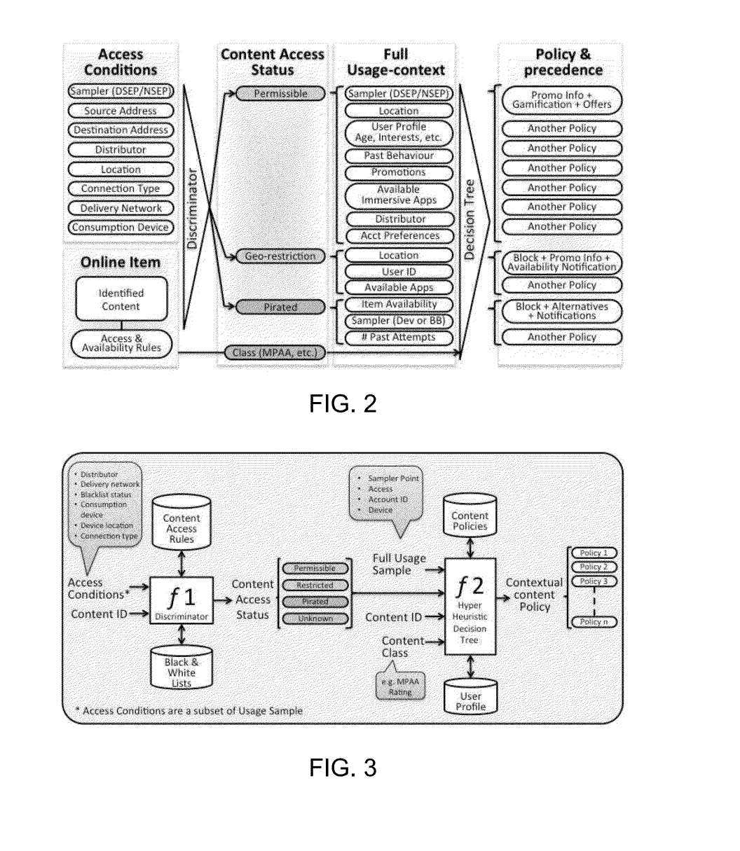

FIG. 2 shows schematically the usage context of streamed content. The identity of the content being streamed and the context under which it is being consumed are the critical items of information used to determine the policies to be applied. Content Sampling and the federated use of commercially available automatic content recognition services are used to identify the content being streamed. Such services are provided by companies such as Gracenote®, Civolution® and Digimarc® Simultaneous sampling of usage conditions is used to establish the full usage context of the content being consumed.

When inspecting each packet the sampler looks for a Media type PDU (Protocol Data Unit). A PDU is analogous to an envelope or package that contains an item. Sometimes the item is a piece of paper with a message or a physical item such as a glass and at other times the item is another envelope. In the same way that an envelope has an address that tells the mail service where to deliver the envelope and the type of content that is contained inside (glass, paper, etc.) a PDU has a header called a packet header that tells the device where to send the content who sent the content and the kind of content inside (called the payload). The packet header is how it can be determined that the payload is a media payload as opposed to another payload such as a text message payload or a voice call payload.

In use, the sampler first looks for media PDUs and inspects their payload. If it cannot determine the PDU type it looks inside the PDU to try and do further pattern matching to see if it is a media PDU that has somehow been hidden. It then takes the payload of several media PDUs and assembles them into a contiguous stream that becomes the media sample.

Automatic Content Recognition services use samples of the content being streamed to detect any embedded watermarks and fingerprints. Detected watermarks and fingerprints are used to reference a database, which in turn provides the streaming media's unique identity. Even in circumstances where the streaming content is user generated or not registered as copyrighted material, the absence of any detectable watermarks is still of significance as it indicates that the content is of unknown origin.

A captured series of data packets, that has either been copied or intercepted, is processed to recover the embedded media stream into its pre-packetized and pre-encoded form. Discrete fragments of the media stream are temporarily stored and tagged with metadata that identifies them as being samples from the stream of data packets that they were taken from.

Sampling can be performed at several locations:
On the play-out device—through interception of data packets before they reach the media player or in the network interface via the Device-based Sampling and Enforcement Point (DSEP)
In the access network via Deep Packet Inspection as the content is being streamed to an end user via the Network-based Sampling and Enforcement Point (NSEP)
In a consumer's network device such as a residential gateway or media server via a DSEP
At the Internet peering point via Deep Packet Inspection as the content is being streamed into the ISP's network via an NSEP.

Recovery of the media stream is dependent on:
The correct temporal reassembly of the data packets
Extraction of the combined data packet payload into a contiguous data stream
Decoding of the data stream into a media stream that can be used for comparison and matching purposes.

As there is no guarantee that data packets will be received in temporal order or, in the case of P2P delivery, received from the same source, the captured data packets are first processed to recover their payload to reform the original data stream. Popular P2P algorithms are used to identify the required data packets from the set of data packets that have been captured. The sampling of the media stream can be performed using established patterns or alternatively by leveraging or adapting a third party sampler such as an Anti-virus checker. The media stream that is sampled by the sampler can thus be either a stream of requested content or content that is played out from the device's storage such as disc, non volatile memory or an external storage device such as a memory stick. Some samplers, in particular anti-virus checkers, look at memory and data storage and so the sampler in this particular context could also effectively sample content that is held on the storage of the device.

The data stream is then further processed using known media encoding algorithms (HLS, Adobe Flash, Silverlight, DASH, etc.) to recover the transmitted or stored media stream.

The usage-context is a complete or partial time-stamped array of sampled usage conditions that have been determined through combining artefacts from the sampler and enforcement point and the context-based online media policy platform. Usage conditions are captured at the same time as the content stream is being sampled.

The usage-context array is a plurality of tuples with each tuple comprising a condition class, a condition attribute and an attribute value. The array is extensible to cater for new types of condition class, condition attribute and attribute value.

Usage contexts are recalculated at regular intervals or when any of the monitored conditions change. Typical condition classes, condition attributes and attribute value examples are shown but not limited to those listed in Table 1.

TABLE 1
Usage Context Attributes

| Condition | | |
|---|---|---|
| Class | Condition Attribute | Attribute Value Example |
| Sampler | Network, Gateway, | Sampling point ID |
| Point | Consumption device, etc. | |
| Access | Distributor | Distributor identifier such as |
| Method | | Amazon, Comcast, etc. |
| | Delivery network | Network type - walled |
| | | garden, Internet |
| | Media stream source | IPv4 Address |
| | address | List or class of content IDs |
| | | that are prohibited from |
| | | being streamed from this |
| | | address. |
| | Media stream destination | List or class of content IDs |
| | address | that are prohibited from |
| | | being streamed to this |
| | | address. |
| | Media Consumption device | IP STB, PC, Game Console, |
| | | Tablet, Smartphone, etc. |
| | Location of the consumption | Country, City, GPS co- |
| | device | ordinates, etc. |
| | Consumption device network | Wired, Wi-Fi, Cellular |
| | connection type | |
| Account | Consumer | Globally Unique ID (GUID), |
| | Enterprise | email etc. |
| | Government | |
| | Hospitality | |
| | Consumption behaviour | Consumed content ID, |
| | | Consumed content |
| | | categories, Content |
| | | purchased, etc. |
| | Configured consumption | Content categories |
| | preferences | |
| | Registered devices | Game consoles, Tablets, |
| | | PCs |
| | Social connections | Social network IDs |
| Device | Type | Model |
| | Operating System | Version |
| | Player | Silverlight, Flash, etc. |
| | Audio and Sound resolution | Display resolution |
| | | Sound configuration |

A Device or Network Sampling and Enforcement Point use the assembled media stream fragments together with the sampled usage-context to form the arguments for a policy request that is sent to the COMP platform.

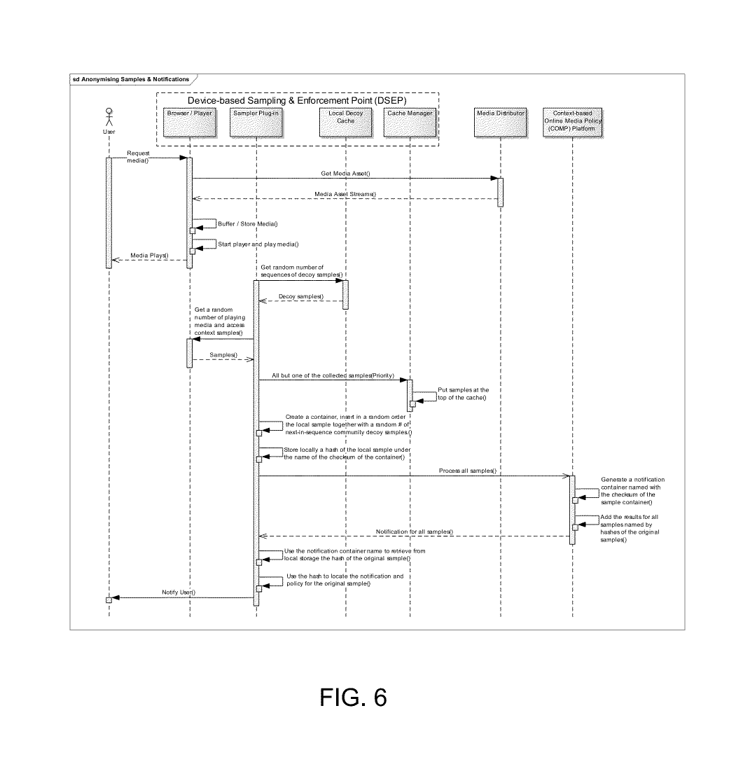

To protect the privacy of the end-user a DSEP is configured to anonymise the arguments of the request that are sent to the COMP platform. It does so by sending multiple decoy samples together with the locally taken media and context sample for processing; see FIG. 6.

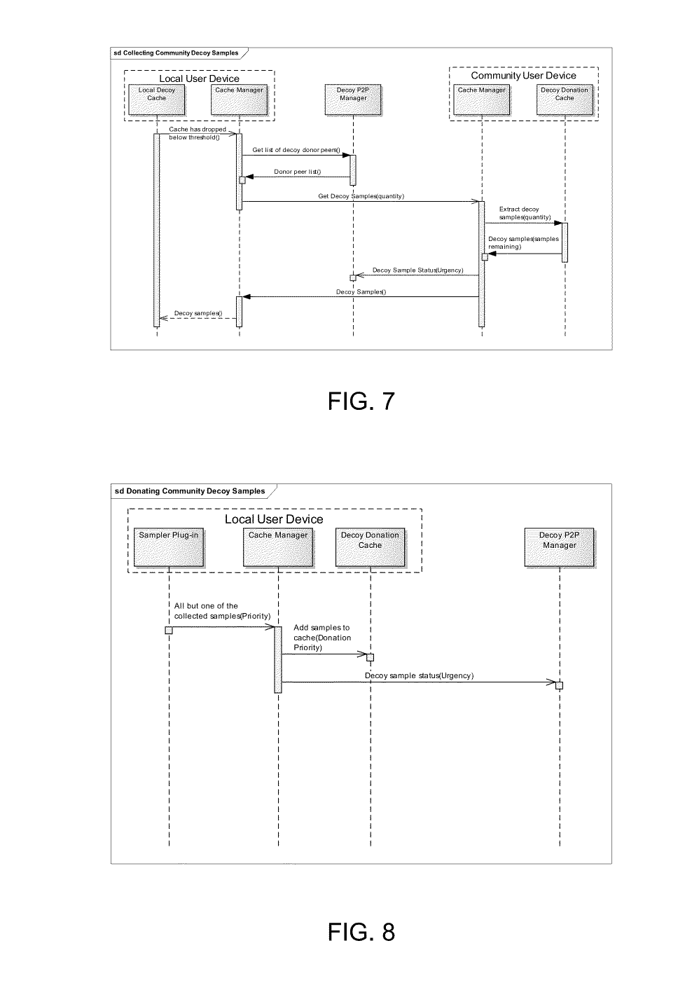

DSEPs use popular P2P protocols to donate and receive decoy samples as required, see FIG. 7 and FIG. 8. On continuous and random intervals each DSEP inserts locally taken content and media samples into its Decoy Donation Cache. At regular intervals a DSEP's Cache Manager notifies the COMP Decoy P2P Manager with the status of its Decoy Donation Cache. Status includes cache depth and whether there are any priority decoys that need sending.

A DSEP's Cache Manager continuously monitors its Local Decoy Cache status. When it falls below a configured threshold it gets a list of donor DSEPs from the Decoy P2P Manager. The Decoy P2P Manager will provide a random list of donors and ensure donors with urgent samples are prioritised over other donors. The DSEP Cache Manager replenishes its Local Decoy Cache with a random numbers of decoy samples from the list of supplied donors.

When a DSEP is ready to send a media and context sample to the COMP for analysis, it takes one of several recently taken samples together with a random number of decoys from its Local Decoy Cache and inserts them into a sample container in a random order. This sample container forms the argument for the policy request that is sent to the COMP. The remaining local samples are put into the Decoy Donation Cache and are marked as high priority so they will be donated as soon as possible. Prior to sending the sample container to the COMP, the DSEP stores the checksum of the container and a hash of the locally taken media and context sample as a linked pair of attributes.

Having processed all of the media and context samples in the received container, the COMP returns a response container that comprises notifications and policy responses for each of the received samples arranged in a random order. A hash for each of the original media and context samples is also inserted into the response container preceding each of their corresponding notification and policy responses. The header of the response container contains the checksum of the original media and context sample container. Having received the response container the DSEP uses the checksum in the response container's header to retrieve the locally stored hash of the original sample. Using the hash, the DSEP extracts the notification and policy that corresponds with the original sample it sent for analysis. The other responses are stored temporarily should there be a need to request additional policy information whilst maintaining privacy.

The COMP platform uses the received media fragment to make a Content ID request to one or more content recognition services via the COMP digital watermark federation service. If the content can be identified, its unique identity is returned by the digital watermark federation service. If the content cannot be identified the returned value is UNKNOWN_CONTENT_ID.

Before declaring the content to be unknown, the COMP platform submits alternative versions of the sample for identification. These versions include but are not limited to separating the audio and video streams, applying noise reduction methods and inverting the image and reattaching it to the audio.

FIG. 3 shows a context based policy determination, in which a two-stage process is used to determine the policy to be that is to be returned to the requesting Sampling & Enforcement Point.

In the first step the system of the invention takes the Content's Identity and Access conditions and uses a discriminator function to determine the Content Access Status of the streaming content. In a second step the system then feeds the Access Status, together with the Content Identity, Full Usage Context and Content Class into a Decision tree to determine the policy that is most relevant to the sampled media stream and its usage context.

The purpose of the discriminator (Function 1) is to determine a media stream sample's Content Access Status. The Content Access Status is the real-time condition that a content item is determined as being consumed under.

The discriminator uses the Content ID to retrieve the content's access rules and their test precedence from the content access rules database. It then uses the sampled media stream and the access conditions extracted from the sampled usage conditions to test each access condition against the access rules in precedence order; see Table 2 for an example of an access rule definition where the content has been identified.

TABLE 2
Discriminator Access Rule Tests

| Test | | | | | | | | | | | |
|---|---|---|---|---|---|---|---|---|---|---|---|
| Subject | Test Focus | Check | Test Result | | | | | | | | |
| Content | Audio and | Correct | [symbol] | ✓ | ✓ | ✓ | ✓ | ✓ | ✓ | ✓ | ✓ or |
| Integrity | Video | sound track, | | or | or | or | or | or | or | or | ? |
| | | no video | | ? | ? | ? | ? | ? | ? | ? | |
| | | inversion | | | | | | | | | |
| Media | IP Address | Blacklisting | | [symbol] | ✓ | ✓ | ✓ | ✓ | ✓ | ✓ | ✓ or |
| stream | | & | | | or | or | or | or | or | or | ? |
| source | | whitelisting | | | ? | ? | ? | ? | ? | ? | |
| address | | | | | | | | | | | |
| Distributor | IP Address | Blacklisting | | | [symbol] | ✓ | ✓ | ✓ | ✓ | ✓ | ✓ or |
| | | & | | | | or | or | or | or | or | ? |
| | | whitelisting | | | | ? | ? | ? | ? | ? | |
| Media | Distributor | Blacklisting | | | | [symbol] | ✓ | ✓ | ✓ | ✓ | ✓ or |
| stream | name | & | | | | | or | or | or | or | ? |
| destination | | whitelisting | | | | | ? | ? | ? | ? | |
| address | | | | | | | | | | | |
| Consumption | Country via | Blacklisting | | | | | [symbol] | ✓ | ✓ | ✓ | ✓ or |
| device | location | & | | | | | | or | or | or | ? |
| location | service/ | whitelisting | | | | | | ? | ? | ? | |
| | GPS | | | | | | | | | | |
| Delivery | Private | Blacklisting | | | | | | [symbol] | ✓ | ✓ | ✓ or |
| network | Network or | & | | | | | | | or | or | ? |
| | Internet | whitelisting | | | | | | | ? | ? | |
| Consumption | Tablet, PC, | Blacklisting | | | | | | | [symbol] | ✓ | ✓ or |
| device | Internet TV | & | | | | | | | | or | ? |
| | | whitelisting | | | | | | | | ? | |
| Network | Wi-Fi, | Blacklisting | | | | | | | | [symbol] | ✓ or |
| connection | Ethernet, | & | | | | | | | | | ? |
| type | Wireless | whitelisting | | | | | | | | | |
| Content | | | Pirated | Pirated | Pirated | Geo- | Geo- | Restricted | Restricted | Restricted | Permissible |
| Access | | | | | | restricted | restricted | | device | | |
| Status | | | | | | | | | | | |

When a test definitively passes or if a pass or fail cannot be determined, the discriminator moves on to the next test. When all tests pass or when all tests are inconclusive or when all tests are a mixture of passed or inconclusive then the Content Access Status is set to PERMISSIBLE. When a test definitively fails the corresponding Content Access Status is set. The value returned by a definitively failed test can be, but is not limited to, PIRATED, GEO_RESTRICTED, NETWORK_RESTRICTED or ACCESS_RESTRICTED.

IP address that repeatedly show up as being a source for PIRATED content are used to both update the blacklist database and provide a real-time feed of IP address which a broadband ISP can choose to block from feeding their network or perform further investigation and take corrective action. It should be noted in this context that Pirated P2P content distribution is often associated with the distribution of malware, in particular bots that can be turned on or off remotely. The user's computer can therefore unwittingly become part of a botnet and they may be unaware that their IP address is used to distribute pirated content.

If the Content ID input to the Discriminator is set to UNKNOWN_CONTENT_ID, the discriminator sets the Content Access Condition to UNKNOWN_CONTENT.

The Content Access Status, determined by the discriminator, together with the content ID, content class and full usage-context conditions, are used by the Hyper Heuristic Decision Tree (Function 2) to determine the policy to be returned to the requesting Sampling and Enforcement point. The user profile database is referenced by function 2 when the identity of the customer forms part of the full usage context and decisions are based on user preferences or past consumption behaviour. It would be possible to use to decision trees other than hyper heuristic decision trees.

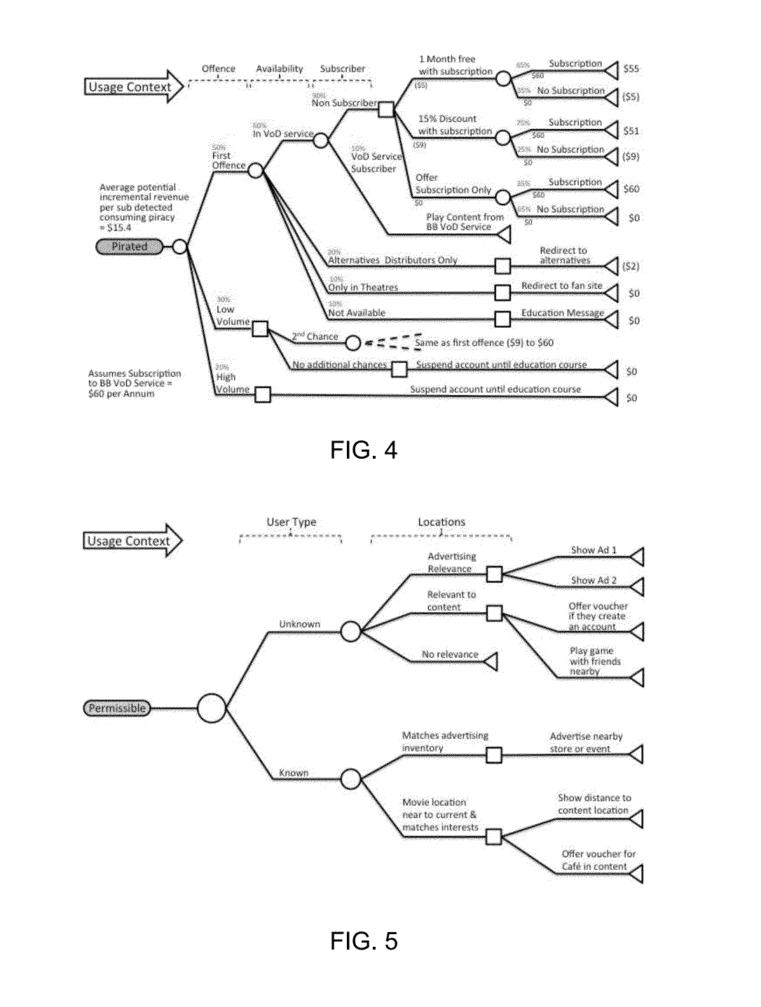

FIG. 4 shows an example of a decision tree for pirated content where decisions need to be made as to whether to prosecute an offender or give them another chance, and if giving another chance whether to incentivize with a discount. Attributes from the sampled usage context are combined with historic activity data to form decision tree events that are used to determine the appropriate decision tree path. In this example the historic frequency of the subscribers IP address having been observed consuming illegal content is used to enable decisions to be made on the basis of the offender being a first time offender, low volume offender or high volume offender. Local databases containing availability status of the desired content and if known the subscription status of the consumer are used to form additional events to enable decisions to be made as to whether to educate, redirect or incentivise the consumer to change their behaviour. For example, a user illegally downloading a film or movie from a peer-to-peer system could be quickly pushed a pop-up message with links to purchase or rent the same content, or advising whether the title in question exists on the video on demand library of a participating distributor's own broadband network or on a third-party seller like Amazon.

FIG. 5 shows a decision tree for permissible content.

The decision tree uses inputs known as events to make decisions. Nodes shown as circles are events and nodes shown as squares are decisions. Events can be whether an identified address has been seen multiple times or whether content is available from another source. Decisions are selecting from one or more alternatives based on a desired outcome that is usually expressed as a probability

Configuration of policies and decision trees that are applicable to specific content titles is described below and shown in FIG. 1a. A precedence value is assigned to all policies to resolve conflicts when more than one relevant policy is identified as being suitable for the content and circumstances under which it is being consumed.

Even when the content sample is unable to be identified and the Content Access Status is set to UNKNOWN_CONTENT a decision tree is still applied to select an appropriate policy based on the full usage context conditions.

Having determined the policy to be applied, the COMP platform retrieves the enforcement instructions from the content policy database and any relevant data needed for instruction execution from the application and user databases and passes them to the requesting sampling and enforcement point as policy enforcement metadata.

Multiple classes of enforcement instruction are combined to create the policy that is to be enforced. Table 3 shows the enforcement instruction classes and their usage.

TABLE 3

| | | User is | |
|---|---|---|---|
| Enforcement Class | Usage | aware | Example |
| Do Nothing | No action | No | Not applicable |
| | required | | |
| Stealth | Redirection | No | Modifying the CDN |
| | Usage metric | | pointer to a less |
| | collection | | congested node. |
| | | | Recording usage |
| | | | context and content |
| | | | consumed |
| Blocking | Stopping | Yes | Disrupting the flow |
| | consumption | | of IP packets |
| Information | Awareness | Yes | Notification of |
| | Promotion | | promotions and |
| | Education | | events |
| Interactive | Changing | Yes | Gamification |
| | behaviour | | |
| | Perform | | |
| | activity | | |
| | Reduce piracy | | |

An example of how a combination of enforcement classes can be used to reduce online piracy is illustrated as follows:

When a known illegal content address or pirated online content is identified, access is prohibited and the user is directed to locations where legal versions of their desired content can be found.

It would also be possible to use gaming techniques to enable consumers to earn reward-points for continued use of the platform to access permissible content. Users can earn additional reward-points through interaction with platform services that are provided or sponsored by content owners and third parties such as advertisers, etc.

Reward-points can be exchanged for either contributed items or additional platform services, see below:
Contributed rewards such as
   Exclusive access to online events and services
   Opportunities to:
      Purchase tickets to exclusive artist events
      Get priority access to public artist events
   Free or discounted merchandising
Service rewards such as
   Unified Catalogue for devices, subscriptions and digital lockers
   Federated recommendations from the top curators and social media
   Searches across multiple OTT vendors

The COMP platform collects and stores usage metadata at ingress of sample data, egress of policies to be applied and at each processing stage leading to the determination of the context-based online media policy to be applied.

To enable correlation of collected events, the COMP platform attaches a Globally Unique ID (GUID) to all samples that it receives. This GUID is maintained at all COMP processing stages and is also embedded as an attribute of any policies returned. This mechanism facilitates correlation of all processing activities associated with a given sample for the purpose of providing:
An audit trail of activities
Feeding heuristic algorithms used by the Decision Tree functions
Building databases for use in subsequent processing of content and usage-context samples.

Examples of stored metadata include but are not limited to:
Time stamped metadata for received media stream samples and their full usage context
Content ID and Content Access Condition
Policy returned
Aggregates of collected data, such as
   History of Content Access Conditions by IP address—used by decision trees to determine repeated scenarios such as absence or presence of repeated piracy
   History of location by User ID —used to offer incentives for visiting local attractions, stores, cafés, etc.

Usage metadata is also collected and stored during application of policies that require interaction with the COMP platform. Again the GUID, first applied to the sample received by the COMP platform and embedded in the returned policy, is maintained during these interactions to enable correlation of metrics over the full sample to policy enforcement.

Metadata is collected as opposed to capturing sampled data to protect privacy of individuals and to reduce the amount of data stored.

### Operation Using a Device-Based Sampler and Enforcement Point

### Device Installation & User Configuration

To install the system on a device, a user downloads the applicable version of the Device-based Sampler and Enforcement Point (DSEP) for the device they are using. It would alternatively be possible for the DSEP to be pre-installed.

If no account exists, the user is required to create an account via the device user interface or a web browser connected to the Internet. Once signed in, the User is able to register their devices and digital lockers and also configure system preferences, which include but are not limited to:
a. Interests for awards
b. Parental controls

In use, a device with the DSEP installed requests content from a site serving online digital media. The DSEP samples the requested URL and IP address and makes a request to the COMP platform for any registered policies to be enforced when these destinations are used.

If a known URL or IP address is detected the relevant policy is returned. Unless a policy redirecting or preventing access to the requested location is returned, the requested site's web page or storefront is presented. Having browsed the available digital assets the user selects a digital asset to consume and the site begins streaming media to the device.

The DSEP samples and captures the received data packets. The DSEP also collects as many usage context attributes as it is able to identify and builds a usage context array. The captured data packet payloads are reassembled into media stream fragments, compressed and sent to the COMP Platform together with the usage context array.

The COMP platform attempts to ascertain the sampled content's unique ID via its watermark and fingerprint federation service. The response is either the content's globally unique identifier as defined by the relevant industry organization such as MovieLabs or Unknown Content ID. Unknown Content ID may be returned because the sampled item is user generated content or not registered with any of the watermark and fingerprint databases used by the COMP platform.

The response from the watermark federation service is passed to the Discriminator (Function 1) together with the available access conditions that have been selected from the usage context sent with the sample from the DSEP. The Discriminator uses the Content ID to retrieve the access rules and the test precedence for the access conditions associated with the identified content from the content access rules database.

Using the sampled media stream and the access conditions extracted from the usage context array, the Discriminator tests each access condition against the access rules in the order specified by the identified content's precedence setting to determine the Access Status of the streamed content. The value of the Access Status can be, but is not limited to, PIRATED, GEO_RESTRICTED, NETWORK_RESTRICTED, ACCESS_RESTRICTED, PERMISSIBLE or UNKNOWN_CONTENT

The newly derived Content Access Status, the Content ID, Full Usage Context and the Content Class are fed into the Hyper Heuristic Decision tree. If a user ID forms part of the full usage context, the user's profile is retrieved from the User Profile database.

The Content Access Status, Content ID and full usage context are used to select the appropriate decision tree for policy selection. The selected decision tree uses all of the available input data and the policy database to determine the policy or policies that best match the circumstances under which the content is being consumed. When more than one policy is available, the policy with the highest precedence is selected. The selected policy is sent to the requesting DSEP. The policy returned to the DSEP can be a sequence of instructions to perform or a URL to a location to retrieve the instructions. Having received the instructions or instruction URL for the content being consumed the DSEP executes them.

PIRATED instructions can be, but are not limited to, displaying a message advising the user that the content they are consuming is illegitimate and optionally:
Advising the reason for the content's illegitimacy
Providing a list of locations where the content can be obtained legally and where applicable the costs for doing so.
Stopping the content playing

RESTRICTED instructions can be, but are not limited to, displaying a message advising the user that the content they are consuming is unauthorized and optionally:
Advising the reason for the lack of authorization
Providing a list of locations where legal and authorized versions of the content can be obtained and where applicable the costs for doing so.
Stopping the content playing

PERMISSIBLE instructions can be, but are not limited to:
Notifying the user of
   Mechanisms to interact with the content they are consuming
   A promotion or event related to the content they are consuming
   Related content that they may like to consume
   The number of reward points they will earn for various percentages of content consumption
Asking the user if they wish to share their activity via a social network
Updating a local history of the items the user has consumed and the location it was consumed at.

Using one of the DSEP menus, Consumers access COMP platform services that are native to the platform or that have been provided by third parties such as Content Owners, Advertisers and third party developers. Native services can include recommendations and library unification services. Third party services are on-boarded to the COMP platform from internal and external contributors. Usage of platform services can earn consumers additional reward-points

Each user earns rewards points every time they consume permissible content via the DSEP interface. Additional rewards points may be earned through interaction with a COMP platform service or application that itself may have been sponsored or provided by a content owner, advertiser or third party application. Service rewards are made available via the DSEP user interface.
i. Access to each service reward requires the use of rewards points that have been earned for using the COMP platform and for consuming legitimate content.
ii. The user is able to browse a library of available service rewards and assign the points that they have earned to enable the service rewards they wish to make use of.

Third party developers are able to contribute new services for inclusion in the service reward library. Contributed rewards are items that can be claimed via the DSEP user interface.
i. Claiming of a contributed reward requires the use of rewards points that have been earned for using the service and for consuming legitimate content.
ii. The user is able to browse a library of contributed rewards and spend the points that they have earned to claim the contributed reward that they wish to have.

### Operation Using a Network-Based Sampler and Enforcement Point

### Deep Packet Inspection Engine Attachment

The Network-based Sampling and Enforcement Point (NSEP) is an application layer service running on or attached to a Deep Packet Inspection (DPI) engine located in the path of a Broadband Access Network.

The DPI is configured to pass all media traffic and traffic that is unable to be determined to the NSEP.

A user's device requests content from a site serving online digital media. The NSEP samples the requested URL and IP address and makes a request to the COMP platform for any registered policies to be enforced when these destinations are used. If a known URL or IP address is detected the relevant policy is returned. Unless a policy redirecting or preventing access to the requested location is returned, the requested site's web page or storefront is returned to the user device. Having browsed the available digital assets the user selects a digital asset to consume and the site begins streaming media to the device via the DPI system

The NSEP samples and captures the received data packets. The NSEP also collects from the DPI engine as many usage context attributes as it is able to identify and builds a usage context array. The captured data packet payloads are reassembled into media stream fragments, compressed and sent to the COMP Platform together with the usage context array.

The COMP platform attempts to ascertain the sampled content's unique ID via its watermark and fingerprint federation service. The response is either the content's globally unique identifier as defined by the relevant industry organization such as MovieLabs or Unknown Content ID. Unknown Content ID may be returned because the sampled item is user generated content or not registered with any of the watermark and fingerprint databases used by the COMP platform.

The response from the watermark federation service is passed to the Discriminator (Function 1) together with the available access conditions that have been selected from the usage context sent with the sample from the NSEP. The Discriminator uses the Content ID to retrieve the access rules and the test precedence for the access conditions associated with the identified content from the content access rules database.

Using the sampled media stream and the access conditions extracted from the usage context array, the Discriminator tests each access condition against the access rules in the order specified by the identified content's precedence setting to determine the Access Status of the streamed content. The value of the Access Status can be, but is not limited to, PIRATED, GEO_RESTRICTED, NETWORK_RESTRICTED, ACCESS_RESTRICTED, PERMISSIBLE or UNKNOWN_CONTENT

The newly derived Content Access Status, the Content ID, Full Usage Context and the Content Class are fed into the Hyper Heuristic Decision tree. The Content Access Status, Content ID and full usage context are used to select the appropriate decision tree for policy selection.

The selected decision tree uses all of the available input data and the policy database to determine the policy or policies that best match the circumstances under which the content is being consumed. When more than one policy is available, the policy with the highest precedence is selected.

The selected policy is sent to the requesting NSEP. The policy returned to the NSEP can be a sequence of instructions to perform or a URL to a location to retrieve the instructions.

Having received the instructions or instruction URL for the content being consumed the NSEP executes them via the DPI API.

PIRATED and RESTRICTED instructions can be, but are not limited to:
Blocking the content
Degrading the content's audio or video quality
Replacing the content with a message advising the user that:
   The content they are consuming is illegitimate
   Advising the reason for the content's illegitimacy
   Providing a list of locations where the content can be obtained legally and where applicable the costs for doing so.
   Stopping the content playing

PERMISSIBLE instructions can be, but are not limited to:
Overlaying a message on the content notifying the user of:
   Mechanisms to interact with the content they are consuming
   A promotion or event related to the content they are consuming

The media policy platform provides a user interface for authorized rights holders, distributors, broadband service providers and consumers alike to define policies (the conditional actions) to be enforced following detection of a media item's identifier and the usage-context, i.e. an event trigger. This is shown in FIG. 1a below.

Event triggers and their policies are used to make content more immersive, reduce online piracy and protect broadband providers and consumers from rights holder litigation.

1. An online media policy platform, comprising: a policy engine, a sampler adapted to sample content of digital media, the sampler being further adapted to request policies from the policy engine that are applicable to the requested content, the platform further comprising a discriminator adapted to determine a condition that the content is to be consumed under, the platform further comprising a decision tree, which decision tree uses inputs from the discriminator to determine which policy to apply to the content, wherein the platform retrieves enforcement instructions from the policy engine and enforces the policy.

2. The online media policy platform according to claim 1, wherein the platform is adapted to determine the identity of sampled content and access rules applicable to the identified content.

3. The online media policy platform according to claim 1, wherein the discriminator determines an access status for the content.

4. The online media policy platform according to claim 3, wherein the access status, the identity of the content and usage context conditions are fed to a decision tree to determine the policy to be applied.

5. The online media policy platform according to claim 4, wherein the policy is returned to the sampler for enforcement.

6. The online media policy platform according to claim 1, wherein the sampler comprises a device or network sampling and enforcement point.

7. The online media policy platform according to claim 6, wherein the platform is adapted to control access to the media.

8. The online media policy platform according to claim 7, wherein access to the media is blocked.

9. The online media policy platform according to claim 8, wherein the user is diverted from the source of the sampled content to an alternative source of the content.

10. The online media policy platform according to claim 1, wherein the platform is adapted to trigger events related to the media.

11. The online media policy platform according to claim 1, wherein the platform is adapted to enforce a policy at an enforcement point in a network or on a device.

12. The online media policy platform according to claim 1, wherein the sampler is adapted to sample a stream of requested content.

13. The online media policy platform according to claim 1, wherein the sampler is adapted to sample content being played out from a device.

14. The online media policy platform according to claim 1, wherein the sampler is adapted to sample content stored on a device.

15. A method of controlling access to online media, comprising the steps of: sampling the media at a sampling point, identifying the content of the media, determining any usage conditions on the content of the media, and controlling further access to the media through the sampling point in dependence on the content of the media and usage conditions.

16. A method of providing a feed of source addresses of malware sites, comprising the steps of: sampling the media at a sampling point, identifying the content of the media, determining any usage conditions on the content of the media, wherein the sampling point identifies the IP address or addresses of the source of the sampled media and if the usage conditions indicate that the source is not a permitted source for the content, the IP address or addresses of the source of the sampled media are supplied to a network provider.
